(19) United States
(12) Patent Application Publication
(10) Pub. No.: US 2006/0221595 A1
(43) Pub. Date: Oct. 5, 2006

(54) Underwater lighting apparatus

(76) Inventor: Tom Payne, Hays, KS (US)

Correspondence Address: Wilson Daniel Swayze, Jr, 3804 Clearwater Ct., Plano, TX, 75025, US

(21) Appl. No.: 11/095,213

(22) Filed: Mar. 31, 2005

(51) Int. Cl. F21V 33/00

(52) U.S. Cl. 362/101; 362/376; 362/267

(57) ABSTRACT

A lamp assembly adapted for underwater use including a guard tube adapted for being filled with water and for forming a hollow housing for the lamp assembly and an inner tube positioned within the guard tube to provide a waterproof environment for the lamp assembly.

### BACKGROUND OF THE INVENTION

The principle of using underwater lighting for security or esthetics around docks and waterways has been challenging because 120-Volt AC and associated current can be extremely dangerous to humans and other forms of life in and around the water. Conventional low voltage lights for example 12-volt DC lamps are not bright enough to illuminate the waterways surrounding docks, piers and moored ships to provide adequate security or esthetic value. Replacing lamps that have burnt out create a special problem with these underwater lights because of the necessary seals for the use of these lights. Once a seal is broken, it is difficult to reestablish this seal. Consequently, most of these underwater lights use lamps which are not replaceable. Since most gas filled lamps such as halogen lamps, do not come in different colors, the ability to change the color of the light to anything but clear has not been possible. However, if a different colored light is desired then the underwater light has to be replaced by another underwater light. This replacement of the entire underwater light is costly because the bulb is a small fraction of the total cost of the underwater light.

### SUMMARY

The single or dual lamp assembly used in this apparatus not only utilizes replaceable lamps but also supplies safe, low voltage light that will light up the water around any dock or waterway. This apparatus utilizes a tube guard that allows the color of light to be easily changed by removing the tube guard of one color and replacing it with another tube guard of another color. It is known in the color spectrum that green light travels further underwater than clear light does. Therefore, in dark and murky waters a green colored light is not only more visible from a greater distance, but also more attractive and desirable for esthetics reasons. The ability to change the color of light as the clarity of water changes is especially important to agencies such as the military that use underwater lighting to provide security around moored ships and waterways and search and rescue agencies that use underwater lights for underwater search and rescue missions. The ability to change the color of light is also a desirable feature for people using lighting for esthetic purposes such as lighting up waters around their dock or pier.

### BRIEF DESCRIPTION OF THE DRAWINGS

FIG. 1 illustrates a cross-sectional view of the duel light apparatus;

FIG. 2 illustrates a cross-sectional view of the hollow housing;

FIG. 3 illustrates a cross-sectional view of the waterproof housing;

FIG. 4 illustrates a cross-sectional view of the light assembly;

FIG. 5 illustrates a cross-sectional view of a lamp.

### DETAILED DESCRIPTION

FIG. 2 illustrates a tube guard 200 which is a hollow housing and includes an apertures or holes 222 to allow water to fill or drain the tube guard 200. The holes 222 may be located anywhere along the hollow housing 200, but holes 222 may be located near either end of tube guard 200 to aid in drainage. The tube guard housing 200 may be constructed from polycarbonate or any suitable extruded transparent shock resistant material. The tube guard 200 protects the inner tube 302 from being broken. Consequently, the tube guard 200 allows the entire assembly to be dropped or jarred without breaking. The tube guard 200 allows a user to change the color of the light by substituting a different tube guard 200 of another color.

It is known that in the color spectrum that green light travels further underwater then clear light does. Consequently, when the water turns dark and murky, a green colored light is desirable to enhance visibility. A quick and easy way of changing from a clear light to a green colored light is equally desirable. By changing the tube guard 200 from a clear tube guard 200 to a green colored tube guard 200, the light emitted from the apparatus is changed to green. There is no need to change the bulb and associated watertight apparatus.

Another benefit associated with the present invention is maintaining a constant bulb temperature to extend the life of the bulb. The tube guard 200 also provides for relatively constant temperature control for the lamp assembly. Gas filled lamps should maintain a constant inner wall temperature for the lamps to burn efficiently. If these gas, filled lamps burn too cold, the filament of the lamp will gradually disintegrate, blacking the lamp surface and failing prematurely. The above mentioned holes 222 allow water to flow between the tube guard 200 and the inner tube 302. The tube guard 200 is sealed on both ends by caps 4, 16. The caps 4, 16 prevent too much water from flowing through the tube guard 200. As a result, the water is substantially restricted within the tube guard 200. When the lamps are lit, the trapped water between the tube guard 200 and the inner tube 302 is heated which keeps the lamps at an appropriate temperature for long life applications. When the tube guard 200 is removed from the water, the water, surrounding the tube guard 200, drains out of the tube guard 200 through holes 222.

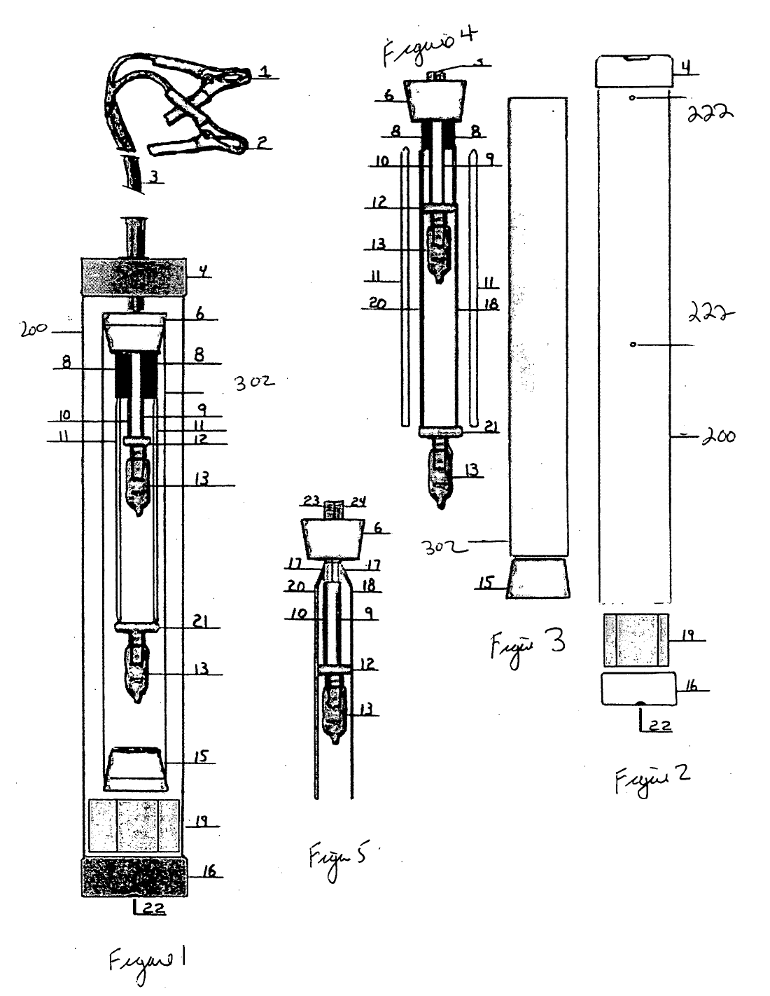

A embodiment of an underwater lighting apparatus constructed in accordance with the present invention is illustrated in FIG. 1. A duel lamp apparatus is illustrated; however, a single or multi-lamp apparatus will not violate the teachings of the present invention. The apparatus includes a dual lamp lighting assembly 12,21 to be mounted in the inner tube 302 which is a hollow housing, a pair of heat shields 11 which are substantially rectangular in shape that protect the conductive wires 18,20 from damage and extends from the rear surface of the lower lamp socket 21 to the shrink tubing 8. FIG. 1 additionally shows the inner tube 302 that provides a substantially watertight enclosure for the dual lighting assembly 12, 21 and is a hollow cylinder that is sufficiently long to enclose the dual lighting assembly 12, 21. The tube guard 200 could be constructed from polycarbonate or any other suitable material and could be another suitable shape. The tube guard 200 is also sufficiently long to enclose the inner tube 302, and the ballast 19 which when present provides a sufficient weight to allow the underwater light assembly to sink; and the tube guard 200 includes caps 4, 16 which could be vinyl or any other suitable material at each end of the tube guard 200 to protect the lamps from breaking and allows the color of the light to be changed by interchanging tube guard 200. These caps 4, 16 by restricting the flow of water provide temperature control for the lighting assembly. A positive battery clip 1 and a negative battery clip 2 attached to the ends of conductive wire 3 which may be water resistant are used to provide power to the lamps.

By constructing the lighting apparatus in accordance with the teaching illustrated in FIG. 1, the apparatus finds utility as a multi-purpose submersible light. The battery clips 1, 2 which are connected at the ends of the conductive wires from the power source 3, may be attached to a battery or any suitable power supply to supply lamps 13 which may be gas filled with power. Battery clips 1, 2 can be removed, and the ends of the conductive wires from the power source may be attached to an optional power converter using near the same voltage as the lamps 13. In this manner, electricity is supplied to the dual lamp lighting assembly 12, 21 which is retained in an enclosure defined as inner tube 302. A removable ballast 19 can be inserted or removed from the base of the tube guard 200 to allow the apparatus to sink to the bottom so that light can be provided at the bottom or to float to provide surface light as needed and should conform to the radial dimensions of the tube guard 202 to prevent the removable ballast 19 from moving within the tube guard 202.

The feature of using a dual lamp lighting assembly 12,21 to provide maximum candle-power output and replacement of burnt out lamps 13 in the underwater lighting devise exists in the present invention and is illustrated in detail in FIG. 2. As shown in this figure, the dual lamp lighting assembly includes lamps 13, sockets 12, 21 to connect the lamps 13 to the conductive wires 9, 10, 18 and 20, heat shields 1, and shrink tubing 8.

The lamps 13 can be any gas filled lamps over any other suitable type of lamps having an output of anywhere from 5 Watts to 200 Watts, and the lamps do not have to include a filament, an envelope formed of hardened glass or quartz, and a pin base. In place of the afore mentioned lamps, a fluorescent, neon or other gas filled tube which contains no filament, envelope of hardened glass or quartz, could also be used to achieve the required light output.

The sockets 12, 21 could be made from a ceramic material or any other suitable material, which could act as a heat sink and would dissipate heat generated from the lamps 13. Conductive wires 18, 20 extending from the rear surface of lower socket 21 could be covered with a heat shields 11 and the ends of the conductive wires 18, 20 could be connected by for example soldering the ends of conductive wires extending from the rear of the top socket 12. Sockets 12, 21 could have, but would not have to have a pair of holes on the front surface, which are spaces apart by a distance equal to the spacing between the pin-contacts of the lamp in order that the pins may be received in the holes. A screw in, snap in or bayonet type of lamp and socket could be used in place of the pin-type socket and lamp. Any of these lamp and base types would allow for the replacement of lamps.

The ends of the conductive wires coming from the power source 23, 24 pass through a central hole in a cap 4. The cap 4 is shown at the top of the tube guard 200.

The ends of the conductive wires coming from the power source 23, 24 pass through a hole which is shown as a central hole in a plug 6 which could be made from rubber or any other suitable material. In order to form a watertight seal without using any form of sealant or adhesive, the outside diameter of the conductive wire 3 coming from the power source, could be slightly larger than the central hole located in the plug 6. When the slightly larger conductive wire 3 is pressed through the slightly smaller hole in the plug 6, a watertight seal is made which should not allow leakage of water into the lighting assembly. Sealant or adhesive could be used as an alternative.

The ends of conductive wires 10, 20 are connected for example by soldering onto the positive conductive wire from the power source 23. The ends of conductive wires 9, 18 are soldered onto the negative conductive wire from the power source 24. The solder joints 17 are covered with shrink tubing 8 for protection and insulation.

The plug 6, which may have tapered sides, is slid into the top of the inner tube 302 making a watertight seal. An additional plug 15 which may be made from solid rubber or any other suitable material is inserted into the bottom of the inner tube 302 to act not only as a watertight seal but also a shock absorber for the replaceable ballast 19 which may be made from lead or any other suitable material that can be added or removed to make the light apparatus either submersible or floating. The removable ballast 19 allows the apparatus to be used as a floating light or as a submersible light. At times, a submerged light is required to illuminate underwater features and for deep-water illumination.

At other times, a floating light is required to illuminate above water features and to mark underwater obstacles. A floating light can also be thrown a distance from the shore or dock, lighting the water around it. If the same thing is done with a light that utilizes internal ballast, it will sink to the bottom, and no light will be projected beyond the surface of the water. The removable ballast 19 can be placed in the tube guard 200, and there can slide freely in the tube guard 200. The plug 15 prevents the inner tube 302 from being damaged by the removable ballast 19.

Inner tube 302 houses the dual lamp assembly 12, 21. However, any glass tubing with a wall thickness of I mm or more could be used. High temperature material such as Pyrex or quartz is not required in this assembly due to the temperature control that tube guard 200 provides.

The inner tube 302 that includes the dual lamp assembly is then slid into to tube guard 200. While in this assembly, the tube guard 200 is constructed from polycarbonate, other extruded, transparent, and shock resistant materials could be used. The tube guard 200 which is colored to a desired color protects the inner tube 302 from easily being broken. The shock resistant tube guard allows the assembly to be dropped or bumped against objects without breaking.

The tube guard 200 also allows the user of the invention to change the color of the light by simply removing one tube guard 200 of one color of tube guard 5 and inserting another tube guard 200. It is known that in the color spectrum, green light travels further underwater than clear light does. Therefore, in dark and murky waters a green colored light is not only more visible from a greater distance, but also more attractive for esthetics reasons.

The tube guard 200 also provides a constant temperature control for the dual lamp assembly 12, 21. Lamps 13 should maintain a constant inner wall temperature in order to burn efficiently. If the lamp burns to cold the lamp filament will gradually disintegrate causing the lamp to turn black and fail prematurely. Holes 222 drilled in the side of the tube guard 200 allow water to fill between the inner tube 302 which could be made from borosilicate and the tube guard 200. The end caps 4, 16 keep the water from escaping. When the lamps 13 are lighted, the trapped water between the tube guard 200 and the inner tube 302 is heated creating a near perfect burning environment for the lamps 13. This temperature control permits the lamps to burn brighter and longer than submersible lights that are exposed directly to cold water temperatures when submerged. When the device is removed from the water, the trapped water, between the tube guard 200 and the inner tube 302, drains from the bottom cap 16.

Thus, although the invention has been illustrated and disclosed with reference to the preferred embodiment, it is understood that substitutions may be made and equivalents employed herein, without departing from the scope of the invention as set forth in the claims.

1) A lamp assembly adapted for underwater use, comprising:
a guard tube adapted for being filled with water and for forming a hollow housing for said lamp assembly;
an inner tube positioned within said guard tube to provide a waterproof environment for said lamp assembly.

2) A lamp assembly adapted for underwater use as in claim 1, wherein said guard tube includes holes to fill and drain said water.

3) A lamp assembly adapted for underwater use as in claim 1, wherein said guard tube is replaceable to change the color of emitted light.

4) A lamp assembly adapted for underwater use as in claim 1, wherein the water between said guard tube and said inner tube is heated to extend the life of said lamp assembly.

5) A lamp assembly adapted for underwater use as in claim 1, wherein said guard tube includes a replaceable ballast.

6) A lamp assembly adapted for underwater use as in claim 1, wherein said guard tube is replaceable.

7) A method for forming a lamp assembly adapted for underwater use, comprising the steps of:
forming a guard tube adapted for being filled with water and for forming a hollow housing for said lamp assembly;
forming an inner tube positioned within said guard tube to provide a waterproof environment for said lamp assembly.

8) A method for forming a lamp assembly adapted for underwater use as in claim 7, wherein the method includes forming holes in said guard tube to fill and drain said water.

9) A method for forming a lamp assembly adapted for underwater use as in claim 7, wherein said guard tube is formed to be replaceable to change the color of emitted light.

10) A method for forming a lamp assembly adapted for underwater use as in claim 7, wherein said guard tube and said inner tube is formed with the water between said guard tube and said inner tube being heated to extend the life of said lamp assembly.

11) A method for forming a lamp assembly adapted for underwater use as in claim 7, wherein said method includes the step of forming a replaceable ballast for said guard tube.

12) A method for forming a lamp assembly adapted for underwater use as in claim 7, wherein said guard tube is formed to be replaceable.

13) A lamp assembly adapted for underwater use, comprising:
a guard tube adapted for being filled with water and for forming a hollow housing for said lamp assembly;
an inner tube positioned within said guard tube to provide a waterproof environment for said lamp assembly.

14) A system including a lamp assembly adapted for underwater use as in claim 13, wherein said guard tube includes holes to fill and drain said water.

15) A system including a lamp assembly adapted for underwater use as in claim 13, wherein said guard tube is replaceable to change the color of emitted light.

16) A system including a lamp assembly adapted for underwater use as in claim 13, wherein the water between said guard tube and said inner tube is heated to extend the life of said lamp assembly.

17) A system including a lamp assembly adapted for underwater use as in claim 13, wherein said guard tube includes a replaceable ballast.

18) A system including a lamp assembly adapted for underwater use as in claim 13, wherein said guard tube is replaceable.
